(19) United States
(12) Patent Application Publication
(10) Pub. No.: US 2025/0304131 A1
(43) Pub. Date: Oct. 2, 2025

(54) SIDE-FOLDING TRAILER THAT DOES NOT RISE IN HEIGHT

(71) Applicant: Wuyi County Haiqiu Technology Co., Ltd., Jinhua (CN)

(72) Inventor: QINGYUAN WU, Bozhou (CN)

(21) Appl. No.: 18/779,176

(22) Filed: Jul. 22, 2024

(30) Foreign Application Priority Data
Mar. 27, 2024 (CN) 202420600272.4

(51) Int. Cl. B62B 3/02

(52) U.S. Cl. CPC B62B 3/02; B62B 2205/06

(57) ABSTRACT

This application discloses a side-folding trailer with a first and second side frame connected by cross bars and a lifting rod at the folding center. The side frames have a base frame assembly connected to the lifting rod. Sliding sleeves on each side of the crossbar set connect to the side frames. The crossbar set includes first, second, fifth, and sixth crossbars with offset centers, minimizing the lifting rod's downward movement. This prevents the lifting rod from interfering with the misaligned and overlapping wheels when folded, optimizing storage. The lifting rod suspending the base frame significantly enhances its load-bearing capacity. The invention relates to outdoor activity equipment and aims to provide a trailer that does not increase in height when folded, ensuring efficient storage and improved load-bearing capacity through its unique design features.

### CROSS-REFERENCE TO RELATED APPLICATIONS

This application claims priority to Chinese Patent Application No. 202420600272.4, filed on Mar. 27, 2024, which is hereby incorporated by reference in its entirety.

### TECHNICAL FIELD

This application relates to the field of outdoor activity equipment, particularly to a side-folding trailer that does not rise in height.

### BACKGROUND

Outdoor activity carts, also known as camping trailers, camp trailers, or field trailers, are typically used in outdoor activities to transport outdoor equipment from indoors or vehicles to the destination. To facilitate storage, most trailers are designed with a foldable structure, usually featuring multiple crossbars set between two side support frames. To ensure stable bottom support, a lifting rod that can suspend the base is usually positioned at the center of the crossbars. However, during storage, the lifting rod moves downward as the crossbars fold, and the wheels on both sides move toward the direction of the lifting rod. This movement can cause the lifting rod to touch the wheels, impacting the storage efficiency. To overcome this drawback, it is necessary to increase the distance between the wheels on both sides after storage, which in turn increases the volume of the trailer after storage. Therefore, this application aims to study how to further reduce the storage space occupied by trailers with lifting rods while ensuring that the lifting rods and wheels do not contact each other.

### SUMMARY

To overcome the shortcomings of existing technologies, the purpose of this application is to provide an outdoor folding trailer that occupies a small space and is stable after storage.

The technical solution adopted by this application is: a side-cross folding trailer that does not elevate, including a first side frame and a second side frame. A cross-bar assembly is set between the first and second side frames, with a hanging rod positioned at the folding center of the cross-bar assembly. The bottoms of the first and second side frames are equipped with a base frame assembly connected to the hanging rod. The sides of the cross-bar assembly are respectively equipped with a first slider that slides in connection with the first side frame, and a second slider that slides in connection with the second side frame.

The cross-bar assembly includes a first cross-bar rotatably connected to the second side frame, a second cross-bar rotatably connected to the first slider, a sixth cross-bar rotatably connected to the first side frame, and a fifth cross-bar rotatably connected to the second slider. The first and second cross-bars are set symmetrically about the axis of the hanging rod with the fifth and sixth cross-bars. The intersection point of the first and second cross-bars is offset towards the side of the second side frame about its vertical central axis.

In some embodiments, the base frame assembly includes a first base frame and a second base frame, which are rotatably interconnected. The first base frame is rotatably connected to the bottom of the first side frame, and the second base frame is rotatably connected to the bottom of the second side frame, with the bottom of the hanging rod located at the connection point between the first and second base frames.

In some embodiments, the cross-bar assembly also includes a third cross-bar that is rotatably connected to both the second and sixth cross-bars, and a fourth cross-bar that is rotatably connected to both the first and fifth cross-bars.

In some embodiments, the third and fourth cross-bars are arranged in a crossing manner, with the top of the hanging rod positioned at their crossing center.

In some embodiments, a handle is fixed on the outer side of the second side frame.

In some embodiments, both the first and second base frames are equipped with two sets of casters at their bottoms.

In some embodiments, when the trailer is folded, the casters at the bottom of the first base frame and the second base frame move towards each other until they overlap.

In some embodiments, when the trailer is folded, the center connection of the first and second base frames drives the hanging rod to move downward.

In some embodiments, after the trailer is folded, the hanging rod is positioned directly above the casters without touching them.

In some embodiments, when the trailer is folded, the hanging rod drives the center of the first and second base frames to move downward.

The beneficial effects of this application are as follows: By setting the first and second sliders at both ends of the cross-bar assembly, the cross-bar assembly drives the hanging rod to move downward during the cross-folding process. Due to the offset structure of the crossing center of the first and second cross-bars, as well as the fifth and sixth cross-bars, the movement distance of the second cross-bar driven by the first slider and the fifth cross-bar driven by the second slider is reduced. This reduction in movement distance prevents the hanging rod from touching the casters, which are misaligned and overlapped after folding, thereby achieving optimal storage effects while ensuring the casters do not impact the hanging rod. Additionally, the structure in which the hanging rod suspends the base frame greatly enhances the load-bearing capacity of the base frame.

### BRIEF DESCRIPTION OF DRAWINGS

FIG. 1 shows a three-dimensional schematic view of the application before folding;

FIG. 2 shows a front view schematic of the application before folding;

FIG. 3 shows a left side view schematic of the application before folding;

FIG. 4 shows a top view schematic of the application before folding;

FIG. 5 shows a top view schematic of the application after folding;

FIG. 6 shows a front view schematic of the application after folding;

FIG. 7 shows a bottom view schematic of the application after folding.

In the figures: 1. Handle; 2. First side frame; 3. Second side frame;
4. Cross-bar assembly; 41. First cross-bar; 42. Second cross-bar;
43. Third cross-bar; 44. Fourth cross-bar 45. Fifth cross-bar;
46. Sixth cross-bar; 5. Casters; 6. First base frame; 7. Hanging rod;
8. Second base frame; 9. First slider; 10. Second slider.

### DETAILED DESCRIPTION OF THE EMBODIMENTS

The following description will clearly and completely illustrate the technical solutions in the embodiments of this application with reference to the accompanying drawings in the embodiments. It is evident that the described embodiments are only part of the embodiments of this application, rather than all of them. Based on these embodiments of this application, all other embodiments obtained by those skilled in the art without creative efforts are within the scope of protection of this application.

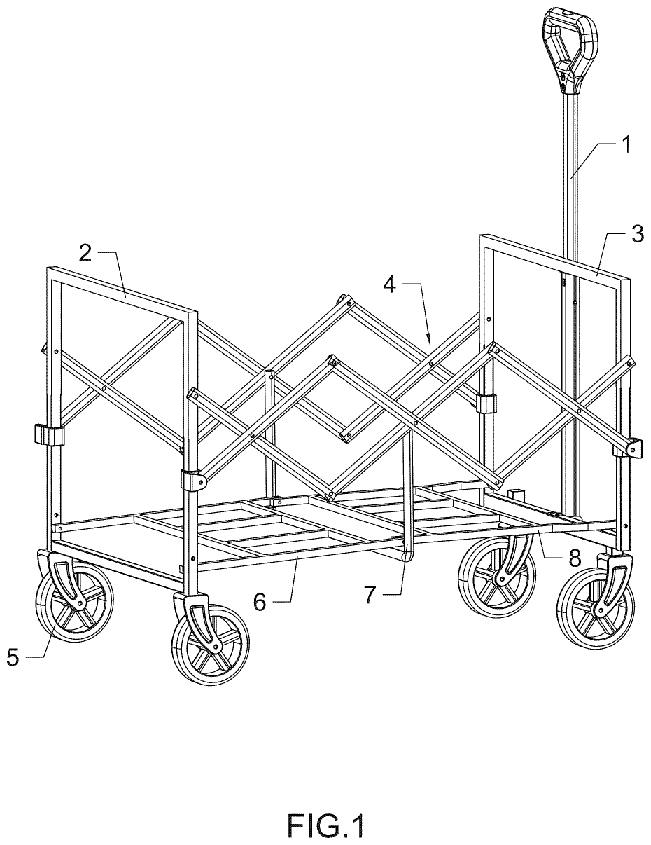

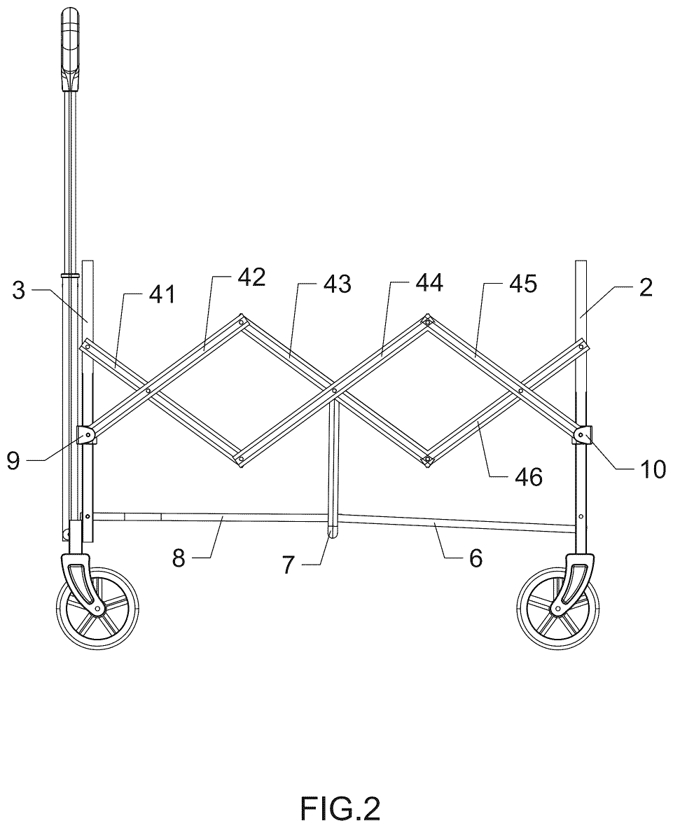

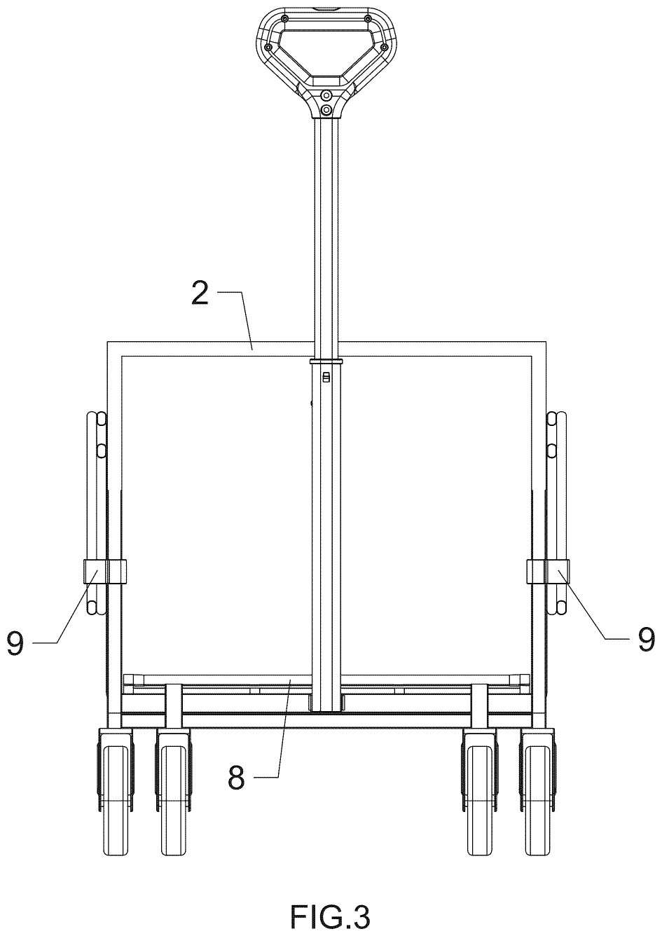

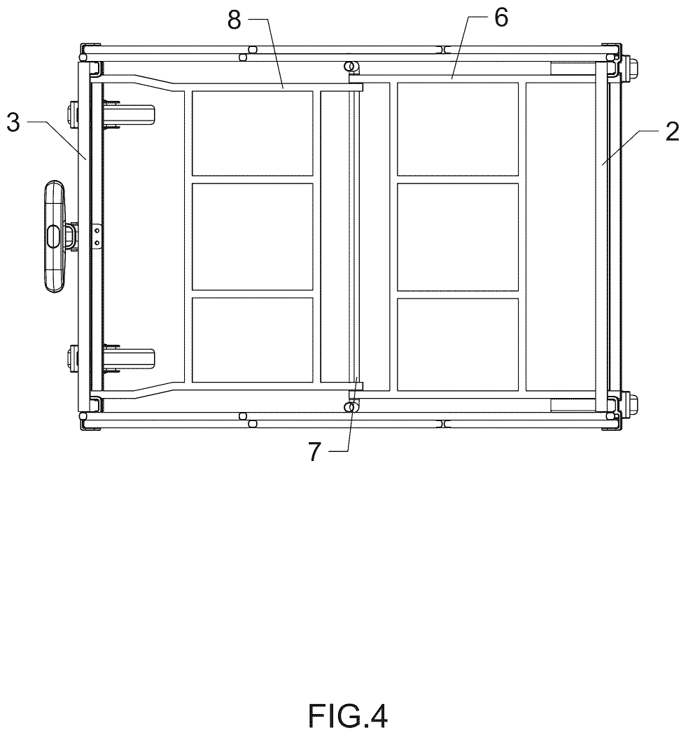

Referring to FIGS. 1 to 4, this application provides a technical solution: a side-cross folding trailer that does not elevate. It includes symmetrically positioned first side frame 2 and second side frame 3, each equipped with two casters 5 at their bottoms. The second side frame 3 is also fixed with an adjustable telescopic handle 1 on its outer side. Between the first side frame 2 and the second side frame 3, there are two cross-bar assemblies 4, composed of first cross-bar 41, second cross-bar 42, third cross-bar 43, fourth cross-bar 44, fifth cross-bar 45, and sixth cross-bar 46. The first cross-bar 41 is connected to the outer side of the second side frame 3 via a pivot, and the sixth cross-bar 46 is connected to the outer side of the first side frame 2 via a pivot.

The second cross-bar 42 is connected to the first slider 9 via a pivot, and the first slider 9 is mounted on the outer wall of the second side frame 3 and slides up and down along it. The fifth cross-bar 45 is connected to the second slider 10 via a pivot, and the second slider 10 is mounted on the outer wall of the first side frame 2 and slides up and down along it. The first cross-bar 41 and the second cross-bar 42 are connected via a pivot, with the connection point biased towards the side of the first slider 9. Similarly, the fifth cross-bar 45 and the sixth cross-bar 46 are connected via a pivot, with the connection point biased towards the side of the second slider 10, The other end of the first cross-bar 41 is connected via a pivot to the fourth cross-bar 44, and the other end of the second cross-bar 42 is connected via a pivot to the third cross-bar 43. Additionally, the other end of the fourth cross-bar 44 is connected via a pivot to the fifth cross-bar 45, and the other end of the third cross-bar 43 is connected via a pivot to the sixth cross-bar 46. The center of the third cross-bar 43 and the fourth cross-bar 44 are connected by a pivot, and at this pivot, the hanging rod 7 is also fixed. The bottom of the first side frame 2 is connected via a pivot to the first base frame 6, and the bottom of the second side frame 3 is connected via a pivot to the second base frame 8, and these base frames are also connected by a pivot, with the bottom of the hanging rod 7 attached to this pivot.

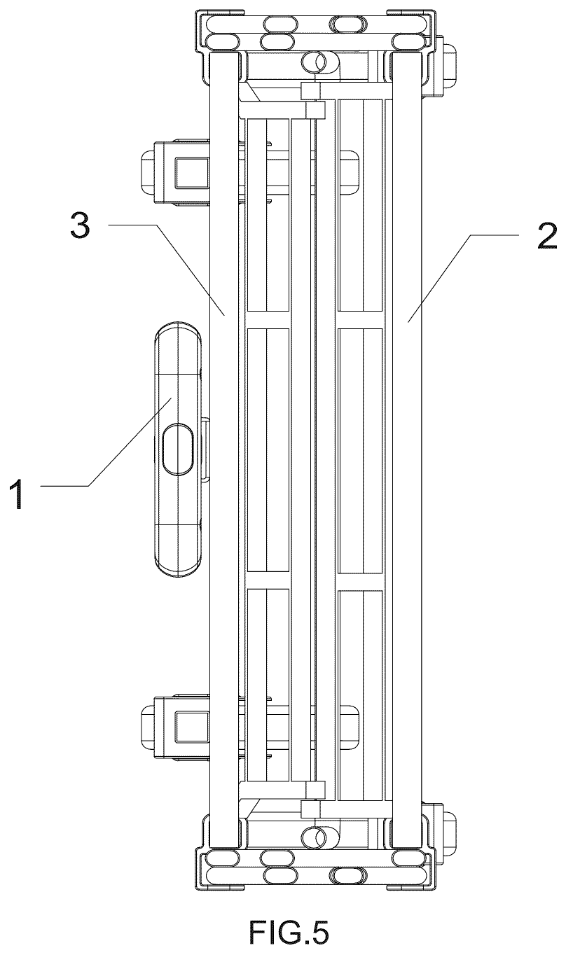

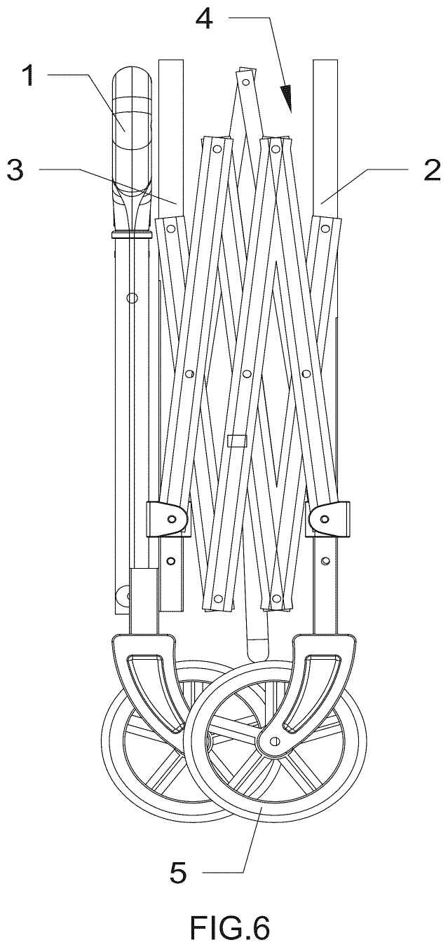

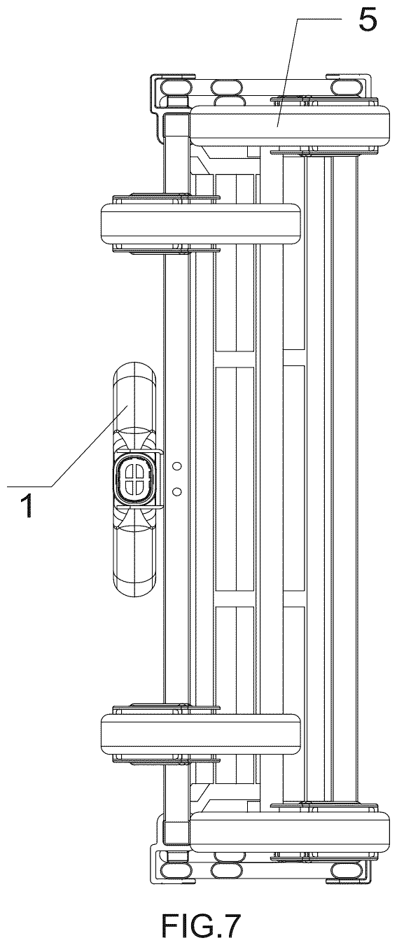

Refer to FIGS. 5 to 7, which illustrate the folding principle of this application trailer. During folding, the first side frame 2 and the second side frame 3 are pressed together, causing them to move closer to each other. At this time, the side angle between the first cross-bar 41 and the second cross-bar 42 increases. The swinging motion of the second cross-bar 42 drives the first slider 9 downward, and the second cross-bar 42 drives the end connected to the third cross-bar 43 downward. Similarly, the side angle between the fifth cross-bar 45 and the sixth cross-bar 46 also increases. The swinging motion of the fifth cross-bar 45 drives the second slider 10 downward, and the fifth cross-bar 45 drives the end connected to the fourth cross-bar 44 downward, Thus, during the folding process where the side angle between the third cross-bar 43 and the fourth cross-bar 44 increases, the crossing center of these bars moves downward, thereby driving the hanging rod 7 downward. The downward movement of the hanging rod 7 drives the process of reducing the angle at the ends of the first base frame 6 and the second base frame 8 for storage. Additionally, due to the offset structure of the crossing centers of the first cross-bar 41 and second cross-bar 42, as well as the fifth cross-bar 45 and sixth cross-bar 46, the movement distance of the second cross-bar 42 driven by the first slider 9 and the fifth cross-bar 45 driven by the second slider 10 is reduced. This reduction in movement distance prevents the hanging rod 7 from touching the casters 5, which are misaligned and overlapped after folding, thus achieving optimal storage effects.

Finally, it should be noted that the above descriptions are merely preferred examples of this application and are not intended to limit its scope. Although the application has been described in detail with reference to the foregoing embodiments, those skilled in the art can still modify the technical solutions recorded in the foregoing embodiments, or equivalently replace some of the technical features. Any modifications, equivalent substitutions, and improvements made within the spirit and principles of this application should be included within the scope of protection of this application.

What is claimed is:

1. A side-folding trailer that does not rise in height, comprising a first side frame and a second side frame, characterized in that a set of crossbars is positioned between the said first side frame and second side frame. A lifting rod is situated at the folding center of the crossbar set. The bottoms of the first side frame and the second side frame are equipped with a base frame assembly connected to the lifting rod. On each side of the crossbar set, there are sliding connections to the side frames: a first sliding sleeve slidingly connected to the first side frame and a second sliding sleeve slidingly connected to the second side frame;
The crossbar set includes a first crossbar pivotally connected to the second side frame, a second crossbar pivotally connected to the first sliding sleeve, a sixth crossbar pivotally connected to the first side frame, and a fifth crossbar pivotally connected to the second sliding sleeve. The first crossbar and second crossbar are arranged symmetrically about the axis of the lifting rod with respect to the fifth crossbar and sixth crossbar, and the intersection of the first crossbar and the second crossbar is offset towards the side of the second side frame relative to their vertical central axis.

2. The side-folding trailer according to claim 1, characterized in that the base frame assembly includes a first base frame and a second base frame which are pivotally connected to each other. The first base frame is pivotally connected to the bottom of the first side frame, and the second base frame is pivotally connected to the bottom of the second side frame. The bottom of the lifting rod is located at the junction of the first base frame and the second base frame.

3. The side-folding trailer according to claim 1, characterized in that the crossbar set further includes a third crossbar which is pivotally connected both to the second crossbar and the sixth crossbar, and a fourth crossbar which is pivotally connected both to the first crossbar and the fifth crossbar.

4. The side-folding trailer according to claim 3, characterized in that the third crossbar and the fourth crossbar are set in a cross configuration and the top of the lifting rod is located at their crossing center.

5. The side-folding trailer according to claim 1, characterized in that a handle is fixed on the outer side of the second side frame.

6. The side-folding trailer according to claim 1, characterized in that the bottom of both the first base frame and the second base frame are equipped with two sets of casters.

7. The side-folding trailer according to claim 6, characterized in that when the trailer is folded, the casters at the bottom of the first base frame and the casters at the bottom of the second base frame come close to each other until they overlap.

8. The side-folding trailer according to claim 7, characterized in that when the trailer is folded, the center connection point of the first base frame and the second base frame drives the lifting rod to move downward.

9. The side-folding trailer according to claim 8, characterized in that after the trailer is folded, the lifting rod is positioned directly above the casters and does not make contact with them.
